(19) United States
(12) Patent Application Publication
(10) Pub. No.: US 2002/0094513 A1
(43) Pub. Date: Jul. 18, 2002

(54) Method and apparatus for collecting, processing and displaying audience-response data

(76) Inventors: Chase Weir, Washington, DC (US); David P. Castler, Grenada Hills, CA (US); Eric Zager, Seattle, WA (US); Elliot Rosenberg, Northridge, CA (US)

Correspondence Address: BANNER & WITCOFF, 1001 G STREET N W, SUITE 1100, WASHINGTON, DC, 20001, US

(21) Appl. No.: 09/916,645

(22) Filed: Jul. 30, 2001

Related U.S. Application Data
(60) Provisional application No. 60/221,554, filed on Jul. 28, 2000.

(51) Int. Cl. G09B 3/00

(52) U.S. Cl. 434/350

(57) ABSTRACT

Method and apparatus for collecting, processing and displaying audience-response data. Audience-response data is electronically collected then processed by a computer for storage and display with corresponding time markers. One or more time markers can be selected for display of corresponding audience-responses for the selected time maker. Accordingly, analysis of the responses can be readily made by the user of the system.

### REFERENCE TO PRIOR APPLICATION

The present application claims priority to Provisional Application Serial No. 60/221,554 filed Jul. 28, 2000 and entitled “Method And Apparatus For Collecting, Processing And Displaying Audience-Response Data.”

### BACKGROUND OF THE INVENTION

The present invention generally relates to the field of public opinion polling and more particularly, is directed to a method and apparatus for collecting, processing and displaying audience-response data.

### DESCRIPTION OF THE DRAWINGS

The present invention will be describe with reference to the following figures in which:

FIG. 1 is a screen shot of Windows NT Employer in accordance with the present invention;

FIG. 2 is a screen shot of the Topline Display in accordance with the present invention;

FIG. 3 is a screen shot of a Cumulative Button Chart in accordance with the present invention;

FIG. 4 is a screen shot of a Pulse Chart in accordance with the present invention;

FIG. 5 is a screen shot of a Score Chart in accordance with the present invention;

FIG. 6 is a screen shot of a Spectator Inspector in accordance with the present invention;

FIG. 7 is a screen shot of a Video Window in accordance with the present invention;

FIG. 8 is a screen shot of a Score Chart in accordance with the present invention;

FIG. 9 is a screen shot of Dial Chart in accordance with the present invention;

FIG. 10 is a block diagram illustrating the basic construction of a computer system which may be used to implement the present invention; and

FIG. 11 illustrates the packet data format which may be used to moved data between various components of the telecommunications network.

### DESCRIPTION OF THE PREFERRED EMBODIMENT

The following is a description of some of the unique features of the present invention as referred to herein as “ViewTrac”. In addition to describing the way some of these features behave, the evolutionary process which led to certain of these components, and some of the reasoning involved, will also be described.

Top Line Display

The top line display evolved rapidly in the initial prototypes to become the focus of the program. Early on, we had settled on the majority of the fundamental data types the program would use, and we was looking for a way to expose these data elements to the user for inspection and manipulation. Two key data types would be the subgroup, a collection of spectators that meet some criteria, and the group, a collection of related subgroups. An example would be the subgroups Male and Female, and the group Gender. More complicated subgroups can be constructed, such as “Males in the age range 31-40 who scored higher in the second half of the program than the first.”

Early prototypes displayed groups and subgroups in an Explorer-style interface, showing a hierarchical tree structure in a pane on the left, with details on the selected element in a pane to the right. The effect was similar to imagining Groups as folders that contained Subgroups. In many ways this was the obvious display to use at the time. Windows 95 was relatively new and had introduced users to the Explorer interface, so it was well understood. The groups and subgroups had a logical relationship that matched this hierarchical structure. It provided a way to identify those elements for other operations, such as drag and drop. The main weakness was that the detail pane could only compare a limited amount of information at a time.

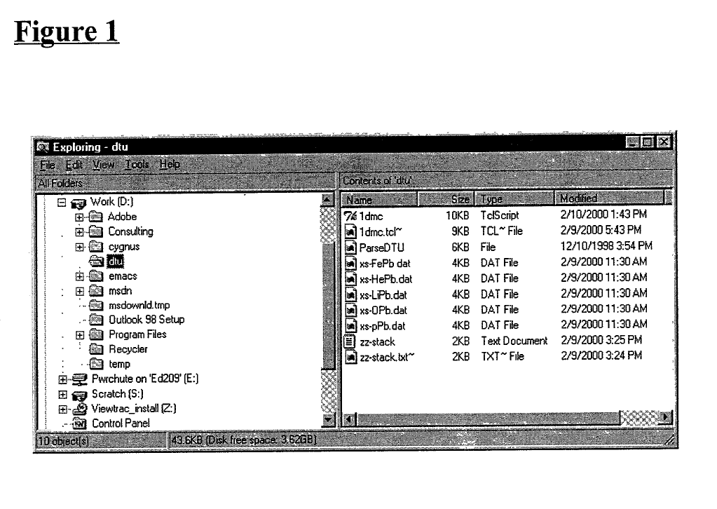

See FIG. 1 which is a screen shot of Windows NT Explorer. The hierarchical view is the pane at the left, details are found in the pane on the right. We were not able to find an old enough version of ViewTrac to have this type of display. Early prototypes had a display of groups and subgroups similar.

The essential limitation was that with the Explorer interface the only way to show details of multiple subgroups was by selecting their parent group. This is just like opening a folder in Windows Explorer to examine the files in that folder. Just as you cannot simultaneous see details on files in different folders in Windows Explorer, we could not compare the subgroups of different groups.

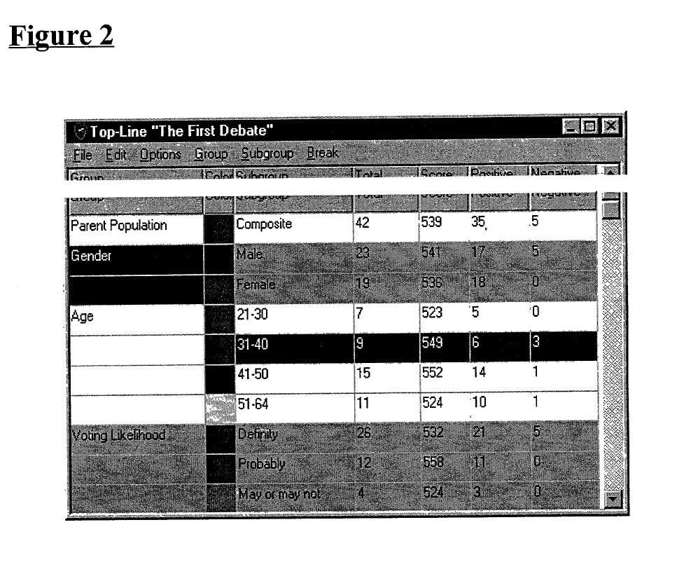

See FIG. 2 which is a screen shot of the current top line display. Both the Group “Gender” and the Subgroup “31-40” are selected.

The breakthrough was combining the layout of the table with behavior similar to that of the left pane of the Explorer. To select a subgroup, the user clicks on the appropriate row anywhere to the right of the Color column. To select a group, the user clicks in the Group column on any row spanned by the group. The Color column provides a visual boundary between the group and the subgroup areas of the display. (The Color column itself is actually part of the subgroup area.) This allows the display of Groups and Subgroups to be compact, and to have both presentation and behavior that preserves the logical structure of the data.

The Topline can also be used as a visual query builder. For instance, the user could select the subgroups “Male” and “21-30,” then use the menu option Subgroup|And to create a new subgroup which contains those spectators who are both male and 21-30. The standard sorts of logical operators are available for subgroups, including AND, OR, and NOT. A “crosstabs” operator is available for pairs of groups, which creates a new group with membership broken along a matrix of each component group. For instance, the crosstabs operation on the groups Gender and Age would create a new group named “Gender-Age” with subgroups “Male 21-30,” “Female 21-30,” “Male 31-40,” and so on. Pop-up windows are available for creating several types of more complicated queries.

Button Charts

ViewTrac collects two types of time-domain data. The first is the Score, a number representing the position of the dial on the handheld unit at a given point in time. The second is a record of button presses. The handheld unit contains two buttons, red and green, which can be pressed any time that the dial is active. ViewTrac records the time at which each button was pressed. The meanings of the red and green buttons are ascribed by the client, and might have interpretations such as “Tune Out” and “Buy Product” for a television infomercial, “Vote Against” and “Vote For” for a political debate, or “Guilty” and “Innocent” for a mock jury.

The score data naturally lends itself to being plotted as a line chart. A line on Score Chart would represent a collection of spectators (a subgroup), and the value to show at a given time is the average position of all dials in that subgroup. But it is less obvious how to display the button presses in a way that also preserves the time-domain data. The TopLine display, described above, can show total presses, but time-domain information is lost. (The TopLine display can be restricted to a specific time interval, instead of the entire span of a test, so time information is not completely lost. But it does not easily convey the time-domain information).

Cumulative Button Chart

The first clients pursued were producers of television infomercials, so we developed the Cumulative Button Chart, tuned to the infomercial. This chart displays time as the horizontal axis. The vertical axis runs from −100% to 100%. In this display, every subgroup is represented with two lines, one a record of the presses of the green button, the other a record of the red button. Presses of the green button deflect cause a deflection in the positive direction, presses of the red button cause a deflection in the negative direction. The size of the deflection is based on the size of the subgroup. If there are 20 people in the subgroup, then the deflection would be 5%. The features that make this display uniquely valuable for infomercial research are that only the first button press for a given spectator is counted, and that the display is cumulative.

In the infomercial context, the buttons would represent “Tune Out” and “Buy Product.” Only the first button presses were thought to be significant since once a person tuned out, they would not see the rest of the clients message and so would not buy, and once they bought, the client would not care if the individual tuned out. It was not deemed interesting to know if a person would press Buy twice, or Tune Out twice.

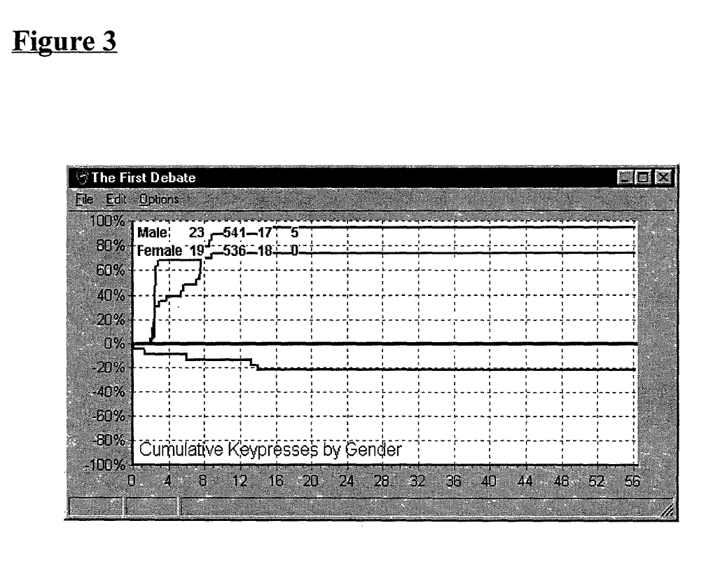

FIG. 3 is a screen shot of the cumulative button chart. The lines above the axis represent presses of the green button, below the axis are presses of the red button.The percentage at any given time is the percentage of respondents who pressed that button first.

The display is cumulative, so at any given time, the positive score shows the percentage of people who pressed the green button first up to that point in time. Similarly the negative score shows the percentage of people who pressed the red button first up to that point in time.

Pulse Button Chart

The Cumulative Button Chart is a good tool for the infomercial client, but we was unhappy with it as a general-purpose display of button data. It is explicitly sensitive only to the first button press of each spectator. But if we were to remove the explicit rule about being sensitive only to the first, by its cumulative nature it is implicitly sensitive to the first press as well. The cumulative chart cannot be sensitive to more than one green press by a spectator, for instance. The interpretation of the line is still “what percentage of the audience pressed the green button up to this point in time?” Multiple presses of the same button do not change the answer to this question.

The Pulse Chart allows the display of multiple presses by the same spectator. The display is similar to the Cumulative Button Chart, with a horizontal time axis and a vertical axis running from −100% to 100%. But the interpretation of each line is “What percentage of people in this subgroup pressed the Red/Green button in the past N seconds?” N is a configurable parameter called the Pulse Width. Thus, a press of the button causes a deflection away from 0% for N seconds, after which the line drops back toward 0%. Two presses by the same spectator in less than N seconds cause the pulse to stretch out, covering a longer span of time. Presses by different spectators in the same time window cause the pulse to be higher.

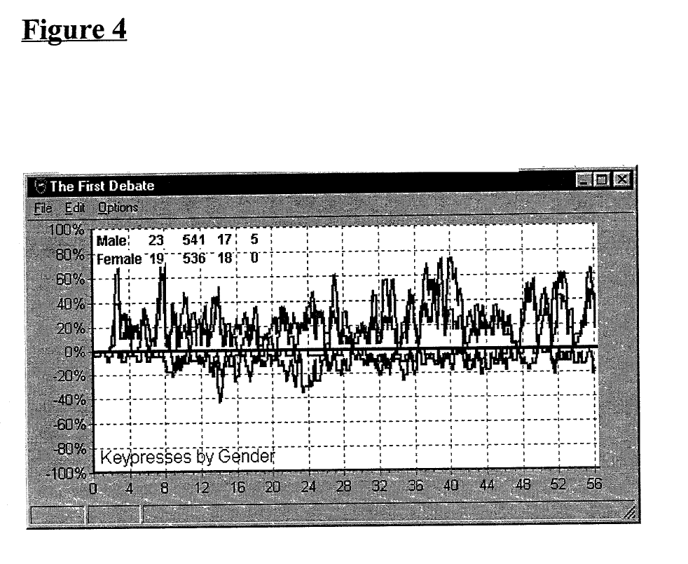

FIG. 4 is a screen shot of the Pulse Chart with 30-second width. The percentage shown is the percentage of respondents who pressed that button at any time in the previous 30 seconds.

The configurable width of the pulse chart is intended to capture the different response times that different people have. For instance, if the punch line of a joke were delivered at exactly five minutes into a presentation, at what point should we say that people have reacted to it? Some people will anticipate the punch line, and will give their response before it has been delivered. Some people might miss the punch line, hear the rest of the audience laugh, and only then understand the joke and give their response. By allowing configuration of the pulse width, we allow room for these variations.

We believe we will find still better ways to present button data, but these have proven useful so far.

Drag and Drop

Drag and drop is used in many parts of the user interface. Concepts such as Groups and Subgroups are presented visually in different places. From one area they may be dragged and dropped into another component, and the target component will display that element in a way unique to that component.

For instance, ViewTrac includes several types of charts. A Score Chart displays a record, by time, of the average dial position of spectators. A Pulse Button Chart shows a record, by time, of the average number of people who have pressed the buttons on our handheld unit within a time window, and a Frequency Chart shows the number of people in each subgroup as a bar chart.

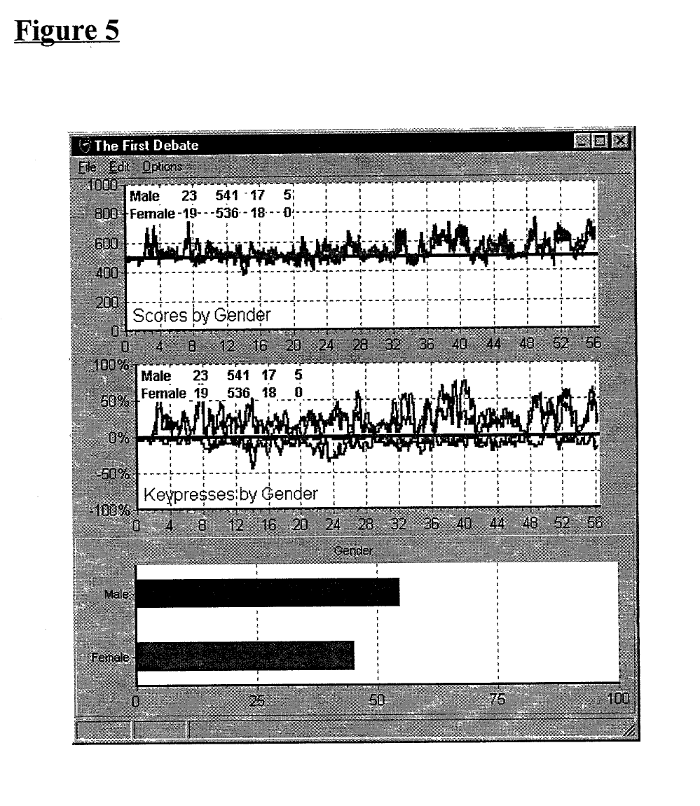

FIG. 5 is a screen shot of a window containing a Score Chart, a Pulse Button Chart, and a Frequency Chart. The group Gender was dropped on each, and each displays information related to that group in a unique way.

Spectator Inspector

The Spectator Inspector is another component that accepts drops. While charts can accept both groups and subgroups as elements to drop, the Spectator Inspector accepts only subgroups. When a subgroup is dropped, a pane on the left lists every spectator who is a member of that subgroup. A pane on the right lists responses associated with a given spectator.

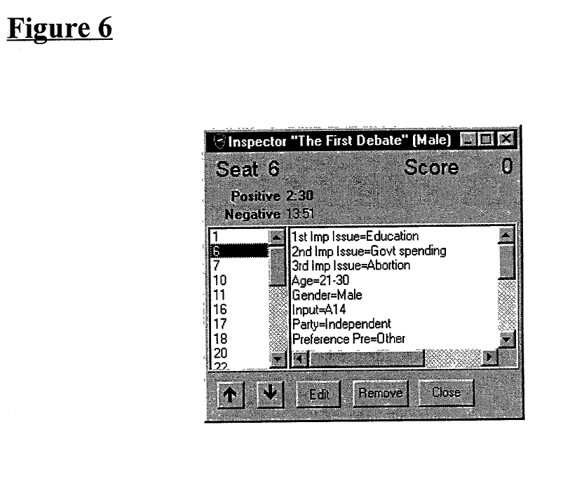

FIG. 6 is a screen shot of the Spectator Inspector after the subgroup “Male” has been dropped. The pane at the left lists the seat number of every spectator who is a member of the “Male” subgroup.

Drag and drop is also used for more abstract operations. For example, an option for the Topline component is to display a Score Interval. When shown, all values shown in the Topline relate to the time span selected in the Score Interval, instead of the entire test. But the Score Interval can be dropped onto a Score or Button Chart, in which case the chart will change its time axis to correspond to that Score Interval.

It should be noted that drag and drop is not the only method available for these operations. The Group to display in an Overlay Chart can be set either through drag and drop, or by a pop-up menu. The popup menu is included for the Overlay Chart because that chart is used during live presentations, when juggling different windows on screen becomes clumsy.

The source of elements to drag is usually the Topline, but this is not envisioned as the only possible source. Another example might be a window containing a simple list of groups, instead of the full-blown Topline. The list of groups could be more compact than the Topline, since it would not display subgroups. Groups could be dragged from there to any other valid target for Groups. This capability does not yet exist.

Video Synchronization

ViewTrac's Video Window allows playback of a variety of multimedia formats. Other displays update themselves to provide information relevant for that time in the test. For instance, the Score and Button charts show a vertical bar that is used as a cursor, to indicate the time into the program. The Topline has an optional column, “Instantaneous Score” which would show the average score of each subgroup at that instant in time. And the Spectator Inspector shows the score of the single selected spectator at that instant in time. These displays maintain their time synchronization, so that pressing the Stop button on the Video window stops all others, and rewinding or fast forwarding the video will move other displays to the appropriate point in time.

In the case of the Score and Button Charts, this communication is two way. When the Video window is active, clicking anywhere in the chart will cause the Video window to advance or move back to the corresponding point in time. For example, if the user noticed an interesting peak in the score chart at the time ten minutes into the test, he could simply click on that peak. The Video Window would move to the ten minute mark, allowing the user to see what was happening in the program at that time.

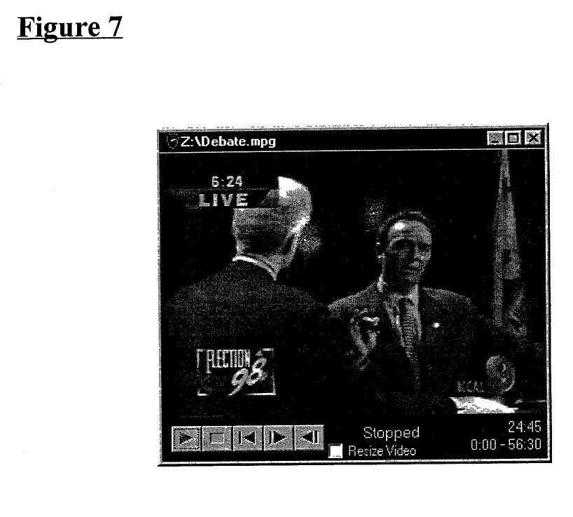

FIG. 7 is a screen shot of a video window Video Window. The user is currently 24 minutes and 45 seconds into the presentation (shown toward the lower right). Clicking on the play button (the green right-triangle) would start the video playing from that point. The rewind and fast forward buttons have the expected meanings.

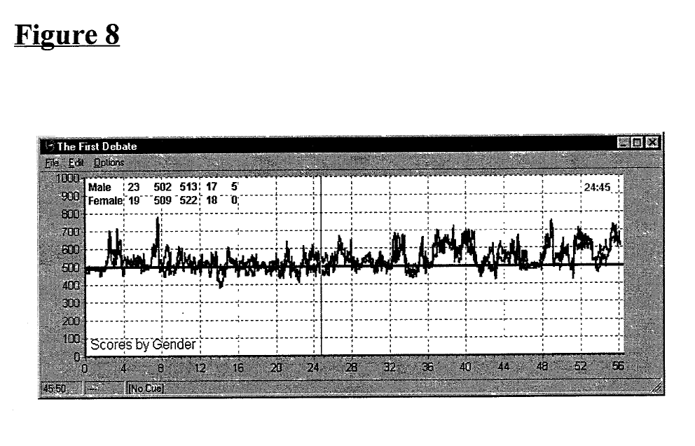

FIG. 8 is a screen shot of a Score Chart with time cursor at 24:45. This cursor tracks the time shown in the video window. As the video plays, the cursor moves to the right. Clicking anywhere in this chart would cause the Video Window to fast-forward or rewind to the corresponding time in the presentation.

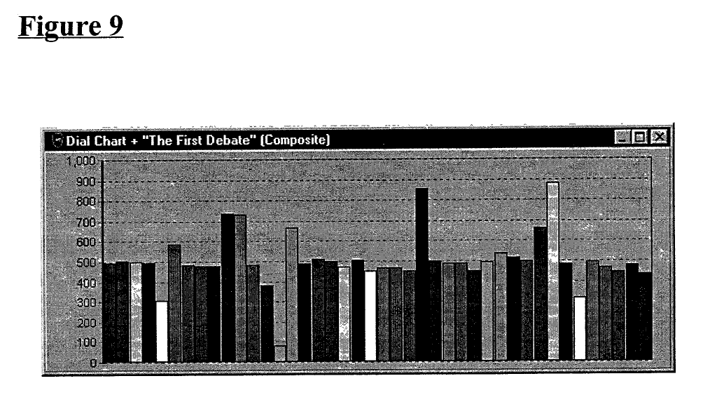

FIG. 9 is a screen shot of the Dial Chart. Each bar represents the position of one spectator's dial at the time 24:45. This display has been somewhat deprecated in favor of the “Bubble Chart.”

Despite its name, the Video Window should work equally well with other sorts of time-based multimedia. For example, an audio-only presentation would obviously not have pictures to display in the Video Window, but the synchronization with the Score Chart and other displays would still be meaningful.

The Video Window also incorporates a “skew” feature. The skew is a time offset to use between the Video Window and all other windows. The offset can be positive or negative. Small skews can be used to correct for simple errors used when recording the data. For instance, the operator might accidentally start recording data a few seconds before or after the actual start of the program. The skew could be used to re-synchronize the data with the display. Sometimes a video presentation will be long enough that because of hard limits, the video data must be separated into several files. For instance, a presentation might be too long for a MPEG file to fit onto a single CDROM. If the presentation has to be split across two CDROM's, a skew of one hour should be used when playing the second hour of the presentation in order for the times to be correctly synchronized.

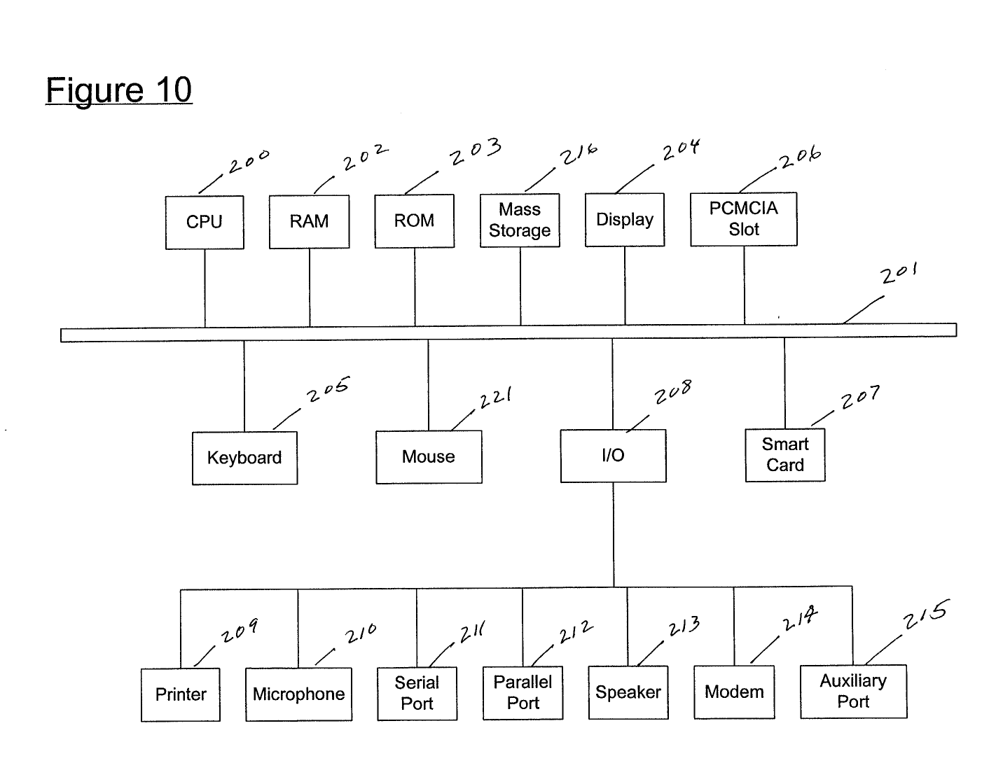

FIG. 10 is a block diagram illustrating the basic construction of the computer system which controls the operation of Applicant's invention. As FIG. 10 shows, the system includes a number of interrelated elements all operationally connected by a buss 201. The system includes RAM memory 202 and ROM memory 203 where instructions and temporary data storage areas of a computer program reside. The system also includes a display 204 and a keyboard 205 so that the various functions of the system and be initiated and observed. Display 205 can be formed of a number of different devices including a liquid crystal display, a cathode ray tube display and an LED display. In addition, a number of different configurations for keyboard 205 can be used. Also included is a pointing device 221, such as a mouse.

The system further includes mass storage device 216 which allow the system to store data to and receive programming instructions from such devices as magnetic floppy disks and tape units.

A PCMCIA “Personal Computer Memory Card International Association” card slot 206 also is provided. Slot 206 defines a 68-pin interface in accordance with current JEIDA PCMCIA standards with respect to physical and electrical specifications. Thus, Type I, Type II and Type III PCMCIA cards can be used with the present invention. Such cards include flash memory, RAM, and ROM, modem devices, LAN adapters, cellular telephone communication devices and mass storage devices such as miniature hard disk drives.

A smart card slot 207 also is provided. The ability to use smart cards allows the system to be automatically configured in a particular way for a particular installation.

Also connected to buss 201 are various input/output (I/O) peripherals 208 which allow the system to communicate with the user and with the outside world through such devices as printer 209, microphone 210, serial port 211, parallel port 212, speaker 213, modem 214 and auxiliary port 215. Printer 209 may be selected from a number of conventional printers known in the prior art. In addition, serial and parallel ports 211 and 212 conform to conventional port standards, also known in the art.

Microphone 210 can be used to provide verbal commands to the system.

Auxiliary port 215 permits other equipment to be easily connected to the I/O port interface. Such equipment includes additional printers, modems, a video camera and image scanners and the like.

The heart of the system is central processing unit (CPU) 200 which supervises the flow of information between the various elements of the system and which perform logic calculations and other functions based on instructions in the computer program stored in RAM 202, ROM 203, a PCMCIA card inserted in PCMCIA slot 206 or a smart card inserted in smart card slot 207 and data associated with the program.

The system also includes a number of other features such as RJ11 and RJ45 telephone connectors.

As the system illustrated in FIG. 10 provides all of the capability of a computer system, it can be easily programmed as such to provide multimedia recording through microphone 210 and a video camera connected to auxiliary port 215 and play back on display 204 and speaker 213. The system may also be used in a video conferencing mode. In so doing, the system has the ability to use any one of a number of compression/decompression algorithms (codecs). A codec is a system for removing or restructuring data to decrease the size of a file. Codecs includes

Cinepak

Intel Indeo Video R3.2

Intel Indeo Video Raw

Microsoft Video 1

Microsoft RLE

QuickTime

Using the computer system described in FIG. 10, the present invention may also be implemented over a computer network, such as the Internet. In most present-day computer networks, data is typically sent from one point to another using established protocols and standards. These protocols and standards allow equipment from various manufacturers and of various designs to exchange data without the need for special interfaces or conversion processes and the like.

A well established way of sending data over a communications network is to partition the data into small packets having a regular format. Each packet, also known in the art as a datagram, includes an electronic address which is used to route the packet across the network to its designation. The packets are then reassembled at the destination and the data restored to its original or some other prearranged format.

Data communications is often conducted in accordance with the Internet Protocol (IP) suite. The IP suite provides for the transmission of packets from source to destination through the various interconnected devices which form the network. While the IP suite does not guarantee delivery of each packet, the integrity of the data carried by the packet, or the order in which the packets arrive at the destination, it does provide error protection for some of the critical information within the packet.

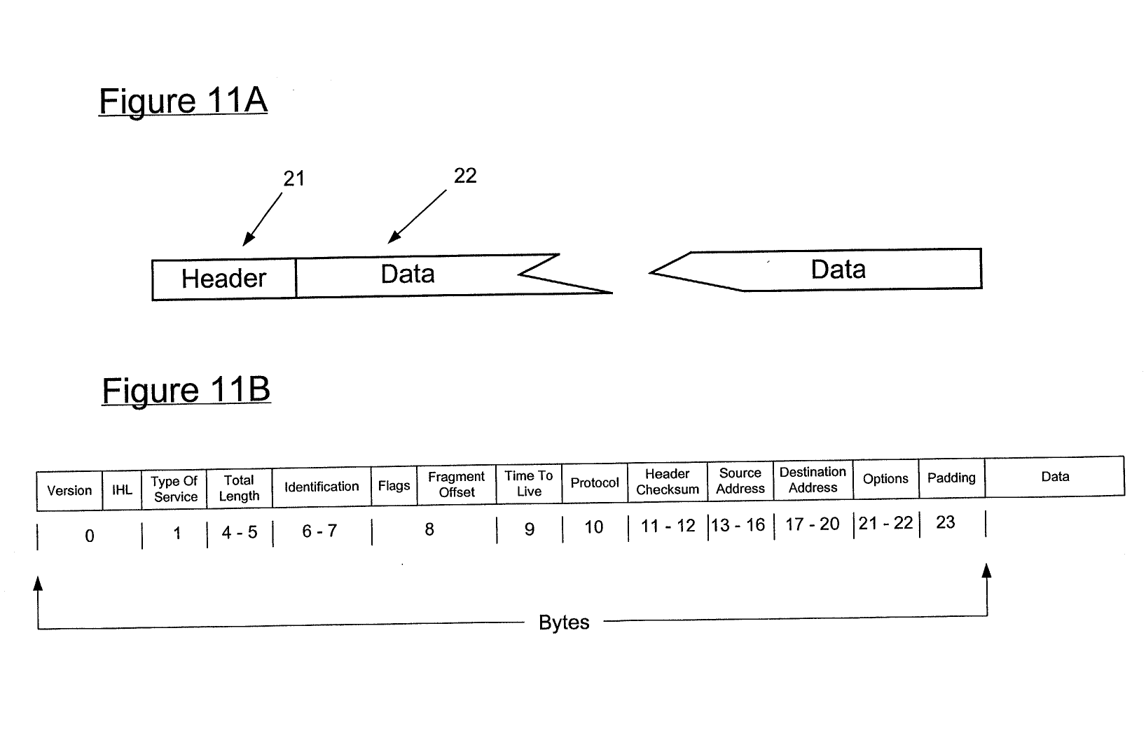

FIG. 11A illustrates the format of an IP packet. The packet includes a header portion 21, which carries control information about the packet, and data portion 22, which contains the data being carried by the packet. Header portion 21 typically has a fixed format and length while data portion 22 may vary in length. FIG. 11B is a more detailed illustration of the format of an IP packet with header portion 21 and data portion 22. As shown in FIG. 11B:

Byte 0 of header 21 includes a 4-bit Version field which indicates the format of the header and a 4-bit Header Length (IHL) field which indicates the length of the Internet header in 32-bit words.

Byte 1 is an 8-bit Type Of Service Field which indicates the type of service which is to be given to the packet.

Bytes 4 and 5 form a 16-bit Total Length field which indicates the total length of the packet (including header and data) measured in octets.

Bytes 6 and 7 form a 16-bit Identification fields which contains a value assigned by the sending device to aid in assembling the packets.

Byte 8 includes a 3-bit Flags field which contains flags controlling fragmentation of the packet and a 13 bit Fragment Offset field which indicates where in the packet this fragment belongs.

Byte 9 is an 8-bit Time To Live field which places a limit on the life span of the packet.

Byte 10 is an 8-bit Protocol field which indicates the protocol associated with the data in the data portion of the packet.

Bytes 11 and 12 form a 16-bit Header Checksum field which represents a checksum computed on the packet header field only.

Bytes 13-16 contain a 32-bit IP address which specifies the Source Address of the packet.

Bytes 17-20 contain a 32-bit IP address which specifies the Destination Address of the packet.

Bytes 21-22 form a variable length Option field.

Byte 23 is a Padding field.

The source and destination IP addresses contained in the packet header are divided into two fields, a network-identifier and a host-identifier. The network-identifier specifies a particular physical network in the Internet and the host-identifier specifies a particular device attached to the specified physical network.

The present invention has the following characteristics and features.

During Data Collection Process

1) The ability to capture two dimensions of respondent reactions to a visual stimuli: One by turning the dial and the other by pressing one or both of the colored buttons.

2) The ability to display in real time these multiple dimensions simultaneously.

3) The ability to display these multiple dimensions on an aggregate, subgroup and individual basis.

4) The ability in real time to alter these displays to capture a variety of subgroups.

5) The ability to display the response levels for any predetermined response alternatives as well as a combination of responses.

6) The ability to show the responses to the current question as well as the previous question in progress.

7) The ability to instantaneous display the responses to any questions by the total audience of any desired subgroups.

After The Data Has Been Collected

1) The ability to instantly display the results for newly created subgroups based on the responses to one or more questions.

2) The ability to visually present the entire data set for any individual, or individuals within any segment of the audience.

3) The exportability of audience and/or any subgroup responses to another spreadsheet program.

4) The ability to create customized displays of the data and save in data files for presentational purposes at a later time.

5) The ability to display the frequencies of the button presses as well as a cumulative net on a second by second basis.

6) The ability to calculate instantaneous response scores by segments and display these segment responses in the appropriate timing sequence.

7) The ability to link the data displayed on a chart with a cd-rom of the visual tested. This link allows the user the ability to point the cursor on any given point on the chart and initiate the video playback to commence instantaneously at that point.

8) The ability to “click and drag” from the subgroup identifier to the Inspector Box to display the respondents who comprise that subgroup.

9) The ability to provide a chart that visually shows the results from multiple tests superimposed on the same chart.

10) The ability to visually present the instantaneous responses on multiple dimensions on adjacent charts.

11) The ability to replay the chart, switching from one subgroup display to another.

12) The ability to replay the chart with the entire graph shown and a vertical cue progressing across the chart depicting the second-by-second responses; or the chart unfolding as was seen when the test was being conducted.

13) The ability to transmit the data to a web site for display.

14) The ability to place on the written charts a text description of what was occurring at specific points in the presentation.

15) The ability to merge data collected outside of the system (e.g. open-end comments) into the system and relate this data with data collected by dials or the keypad.

16) The ability to remove any respondent from the sample and provide results from the audience members that remain.

17) The ability to vary from the intended script or add any new questions “on the fly”.

18) The ability to create the particular shell for a desired display of instantaneous responses and simply click and drag to display the responses by any desired subgroup.

While there are given above certain specific examples of this invention and its application in practical use, it should be understood that they are not intended to be exhaustive or to be limiting of the invention. On the contrary, these illustrations and explanations herein are given in order to acquaint others skilled in the art with this invention and the principles thereof and a suitable manner of its application in practical use, so that others skilled in the art may be enabled to modify the invention and to adapt and apply it in numerous forms each as may be best suited to the requirement of a particular use.

We claim:

1. An apparatus for collecting, processing and displaying audience-response data, said apparatus comprising:
response data input means for collections response data from members of an audience;
processing means coupled to said response data input means for processing said response data;
time means for providing a time maker associate with said response data;
storage means coupled to said processing means and said time means for storing said response data and said time marker; and
display means coupled to said storage means for displaying said response data and said time marker.
